(19) United States
(12) Patent Application Publication
(10) Pub. No.: US 2023/0358885 A1
(43) Pub. Date: Nov. 9, 2023

(54) SONAR STEERING FOR LURES

(71) Applicant: NAVICO HOLDING AS, Egersund (NO)

(72) Inventor: Matthew Laster, Broken Arrow, OK (US)

(21) Appl. No.: 17/738,252

(22) Filed: May 6, 2022

(51) Int. Cl. G01S 15/96; G01S 7/62; G01S 15/42

(52) U.S. Cl. CPC G01S 15/96; G01S 7/6218; G01S 15/42

(57) ABSTRACT

A sonar system for a watercraft is provided. The sonar system includes a sonar assembly configured to attach to the watercraft. The sonar assembly includes one or more sonar transducers elements configured to transmit one or more sonar beams into an underwater environment relative to a facing direction dictating a coverage volume of the one or more sonar beams. The sonar assembly includes a display, one or more processors and a memory including computer program code. The computer program code causes the one or more sonar transducer elements to emit one or more sonar beams defining the coverage volume, receive sonar return data, determine a position of the lure, adjust the facing direction of the sonar assembly to position the lure within the coverage volume, and cause presentation of a sonar image corresponding to the coverage volume of the underwater environment and including a representation of the lure.

### FIELD OF THE INVENTION

Embodiments of the present invention relate generally to castable devices and, more particularly, to systems, assemblies, and associated methods for steering sonar to track castable devices.

### BACKGROUND

Sonar systems used with marine devices are designed to present an image of an underwater environment. The sonar systems are configured to send out one or more sonar beams which echo off surfaces and return to the sonar system.

Fishing lures are used to attract and/or catch fish during fishing. A fishing lure may be cast into the underwater environment. It may be difficult to understand or confirm where the fishing lure is in the underwater environment and such knowledge would prove useful for fishing activities.

### BRIEF SUMMARY OF THE INVENTION

Incorporating sonar imagery into fishing allows an angler to “see” the underwater environment while fishing. Sonar images may be used to find desirable structure (which may correlate to fish therearound), determine the type and/or quantity of fish in an underwater environment, among many other things.

In some cases, it may be desirable for the fisherman to “see” their fishing lure within the sonar imagery. This could provide many benefits, including enabling verification that the fishing lure is in the proper spot (e.g., near the structure, near a school of fish, etc.). However, it can be difficult for a fisherman to land the lure in the proper spot that is within the sonar coverage volume. Further, the fisherman may not be spatially aware of where that coverage volume is in the underwater environment (e.g., left, right, deeper, etc.). Moreover, manually controlling a sonar view, e.g., by manually adjusting the facing direction (and coverage volume) of the sonar image may to find the lure may be difficult (e.g., the sonar coverage may be narrow in a certain direction, the fisherman may be engaged in other activities, such as holding a fishing rod, etc.).

Accordingly, some embodiments of the present invention provide a sonar system that automatically steers (e.g., mechanically, electrically, etc.) the sonar system such that the lure is within the coverage volume of the sonar. This allows the fisherman to easily see the lure within the sonar image. Further, the system may be configured to detect and distinguish the lure within the sonar image, thus allowing the fisherman to easily distinguish the lure from fish or other objects in the surrounding coverage volume.

The lure may contain electronics equipment contained within the lure body to communicate with a communication interface to indicate a location such that the sonar assembly may rotate such that an emitting face of the sonar assembly is directed towards the lure. The lure may further include a signal generator to generate a signal to the communications interface such that the system may identify the signal as the lure.

Additional example embodiments of the present invention include apparatuses, methods, systems, and computer program products associated with various embodiments described herein.

In an example embodiment, a sonar system is provided. The sonar system comprises a sonar assembly configured to attach to a motor associated with a watercraft. The motor is configured to propel the watercraft to travel along a direction of travel in a body of water. The sonar assembly comprises one or more sonar transducer elements. The one or more sonar transducer elements are configured to transmit one or more sonar beams into an underwater environment relative to a facing direction. The facing direction dictates a coverage volume of the one or more sonar beams within the underwater environment. The sonar system further comprises a display, one or more processors, and a memory including a computer program code. The computer program code is configured to, when executed, cause the one or more processors to cause the one or more sonar transducer elements to emit the one or more sonar beams into the underwater environment to define the coverage volume. The computer program code is further configured to, when executed, cause the one or more processors to receive sonar return data from the coverage volume of the one or more transducer elements, and determine, based on either the received sonar return data or a beacon signal emitted by a lure, a position of the lure within the underwater environment. The computer program code is further configured to, when executed, cause the one or more processors to adjust the facing direction of the sonar assembly to cause the lure to be positioned within the coverage volume, and cause, on the display, presentation of a sonar image corresponding to the coverage volume of the underwater environment. The sonar image includes a representation of the lure within the coverage volume.

In some embodiments, the lure may comprise at least one sensor. In some embodiments, the beacon signal may be emitted after the at least one sensor detects water from the underwater environment.

In some embodiments, the computer program code may be further configured to, when executed, cause the one or more processors to receive indication of a user selection of the representation of the lure within the sonar image; receive updated sonar return data from the coverage volume of the one or more sonar transducer elements indicating an updated position of the lure; and adjust the facing direction of the sonar assembly to cause the updated position of the lure to be centered within the coverage volume, so as to track the lure within the sonar image.

In some embodiments, the orientation of the sonar assembly may be adjusted by at least one of rotating or trimming the motor associated with the watercraft. In some embodiments, the beacon signal may be a sonar signal. In some embodiments, the presentation of the sonar image on the display may distinguish between sonar return data and the sonar signal emitted by the lure.

In some embodiments, the beacon signal may be a GPS position. The computer program code may be further configured to, when executed, cause the one or more processors to, cause, in response to receiving the beacon signal emitted by the lure, the sonar assembly to rotate such that the representation of the lure is centered within the sonar image.

In some embodiments, the lure may be a first lure and a second lure. The computer program code may be further configured to, when executed, cause the one or more processors to determine, based on the received sonar data or a first beacon signal emitted by the first lure a position of the first lure within the underwater environment; determine, based on the received sonar return data or a second beacon signal emitted by the second lure, a position of the second lure within the underwater environment; and adjust the facing direction of the sonar assembly to cause at least one of the first lure and the second lure to be positioned within the coverage volume.

In some embodiments, the motor associated with the watercraft may comprise a steering system, and the lure may be a first lure and a second lure. The computer program code may be further configured to, when executed, cause the one or more processors to determine, based on the received sonar data or a first beacon signal emitted by the first lure a position of the first lure within the underwater environment; determine, based on the received sonar return data or a second beacon signal emitted by the second lure, a position of the second lure within the underwater environment; receive a user input selecting one of the first lure or the second lure; and adjust the facing direction of the sonar assembly to cause at least one of the first lure and the second lure to be positioned within the coverage volume.

In some embodiments, the sonar image may be a two-dimensional live sonar image formed from the sonar return data. In some embodiments, the computer program code may be further configured to, when executed, cause the one or more processors to cause, on the display indication of at least one lure adjustment to direct a user where to move the lure from the position to a second position within the underwater environment that is within the coverage volume. In some embodiments, the beacon signal may be a wireless signal.

In another example embodiment, a sonar system is provided. The sonar system comprises a sonar assembly configured to attach to a watercraft. The sonar assembly comprises one or more sonar transducer elements, configured to transmit one or more sonar beams into an underwater environment relative to a facing direction. The facing direction dictates a coverage volume of the one or more sonar beams within the underwater environment. The sonar assembly further comprises a sonar steering assembly configured to adjust the facing direction of the one or more sonar transducer elements relative to the watercraft, a display, one or more processors and a memory including a computer program code. The computer program code is configured to, when executed, cause the one or more processors to cause the one or more sonar transducer elements to emit the one or more sonar beams into the underwater environment to define the coverage volume; receive sonar return data from the coverage volume of the one or more sonar transducer elements; determine, based either on the received sonar return data or a beacon signal emitted by a lure, a position of the lure within the underwater environment; adjust, via the sonar steering assembly, the facing direction of the sonar assembly to cause the lure to be positioned within the coverage volume; and cause, on the display, presentation of a sonar image corresponding to the coverage volume of the underwater environment. The sonar image includes a representation of the lure within the coverage volume.

In some embodiments, the lure may comprise at least one sensor. The beacon signal may be emitted after the at least one sensor detects water from the underwater environment.

In some embodiments, the computer program code may be further configured to, when executed, cause the one or more processors to receive indication of a user selection of the representation of the lure within the sonar image; receive updated sonar return data from the coverage volume of the one or more sonar transducer elements indicating an updated position of the lure; and cause the sonar steering assembly to adjust the facing direction of the sonar assembly to cause the updated position of the lure to be centered within the coverage volume, so as to track the lure within the sonar image.

In some embodiments, the lure may be a first lure and a second lure. The computer program code may be further configured to, when executed, cause the one or more processors to determine, based on the received sonar data or a first beacon signal emitted by the first lure a position of the first lure within the underwater environment; determine, based on the received sonar return data or a second beacon signal emitted by the second lure, a position of the second lure within the underwater environment; and adjust the facing direction of the sonar assembly to cause at least one of the first lure and the second lure to be positioned within the coverage volume.

In some embodiments, the computer program code may be further configured to, when executed, cause the processor to cause on the display indication of at least one lure adjustment to direct a user where to move the lure from the position to a second position within the underwater environment that is within the coverage volume.

In yet another example embodiment, a method for adjusting a facing direction of a sonar assembly is provided. The method comprises causing one or more sonar transducer elements of the sonar assembly to emit one or more sonar beams into the underwater environment to define a coverage volume. The method further comprises receiving sonar return data from the coverage volume of the one or more sonar transducer elements. The method further comprises determining, based on either the received sonar return data or a beacon signal emitted by a lure, a position of the lure within the underwater environment. The method further comprises adjusting via a steering system attached to the sonar assembly or a motor to which the sonar assembly is attached, the facing direction of the sonar assembly to cause the lure to be positioned within the coverage volume. The method further comprises causing, on the display, presentation of a sonar image corresponding to the coverage volume of the underwater environment, wherein the sonar image includes a representation of the lure within the coverage volume.

In some embodiments, the lure may comprise at least one sensor. The beacon signal may be emitted after the at least one sensor detects water from the underwater environment.

In some embodiments, the method may further comprise receiving indication of a user selection of the representation of the lure within the sonar image. The method may further comprise receiving updated sonar return data from the coverage volume of the one or more transducer elements indicating an updated position of the lure. The method may further comprise adjusting the facing direction of the sonar assembly to cause the updated position of the lure to be centered within the coverage volume, so as to track the lure within the sonar image.

In some embodiments, the lure may be a first lure and a second lure. In some embodiments, the method may further comprise determining, based on the received sonar return data or a first beacon signal emitted by the first lure, a position of the first lure within the underwater environment. In some embodiments, the method may further comprise determining, based on the received sonar return data or a second beacon signal emitted by the second lure, a position of the second lure within the underwater environment. The method may further comprise adjusting the facing direction of the sonar assembly to cause at least one of the first lure and the second lure to be positioned within the coverage volume.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an example watercraft in accordance with some embodiments described herein;

FIGS. 2A-2B illustrate example sonar systems in accordance with some embodiments described herein;

FIG. 3A illustrates an example sonar assembly configured for use with a watercraft, in accordance with some embodiments discussed herein;

FIG. 3B illustrates an example array of transducer elements, in accordance with some embodiments discussed herein;

FIG. 3C illustrates an example arrangement of three example arrays arranged to provide continuous sonar coverage utilizing beamformed sonar return beams, in accordance with some embodiments discussed herein;

FIG. 3D illustrates an example marine electronics device presenting a two-dimensional (2D) live sonar image corresponding to the sonar coverage shown in FIG. 3C, in accordance with some embodiments discussed herein;

FIG. 4 illustrates an example lure, in accordance with some embodiments discussed herein;

FIGS. 5A-D illustrate an example direction change of the sonar system such that the lure is within the coverage volume of the sonar system, in accordance with embodiments discussed herein;

FIG. 5E illustrates an example sonar image resulting from the sonar system illustrated in FIG. 5D, in accordance with some embodiments discussed herein;

FIG. 6A illustrates an example sonar system for use with multiple lures, in accordance with some embodiments discussed herein;

FIG. 6B illustrates an example chart illustrating the position of each lure in relation to the watercraft, in accordance with some embodiments discussed herein;

FIG. 6C illustrates the example sonar system rotating to the capture one of the lures within the coverage volume, in accordance with some embodiments discussed herein;

FIG. 6D illustrates an example sonar image generated by the sonar system of FIG. 6A, where the sonar system has adjusted its direction such that both lures are within the coverage volume, in accordance with some embodiments discussed herein;

FIG. 7 illustrates a block diagram of an example marine system, in accordance with some embodiments discussed herein; and

FIG. 8 illustrates a flow chart of an example method of operating a sonar system, in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

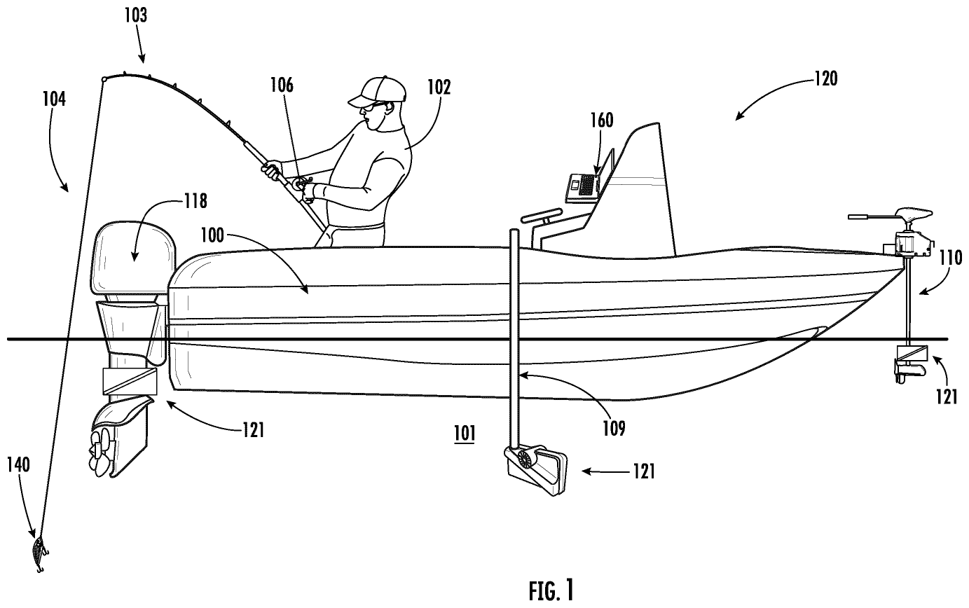

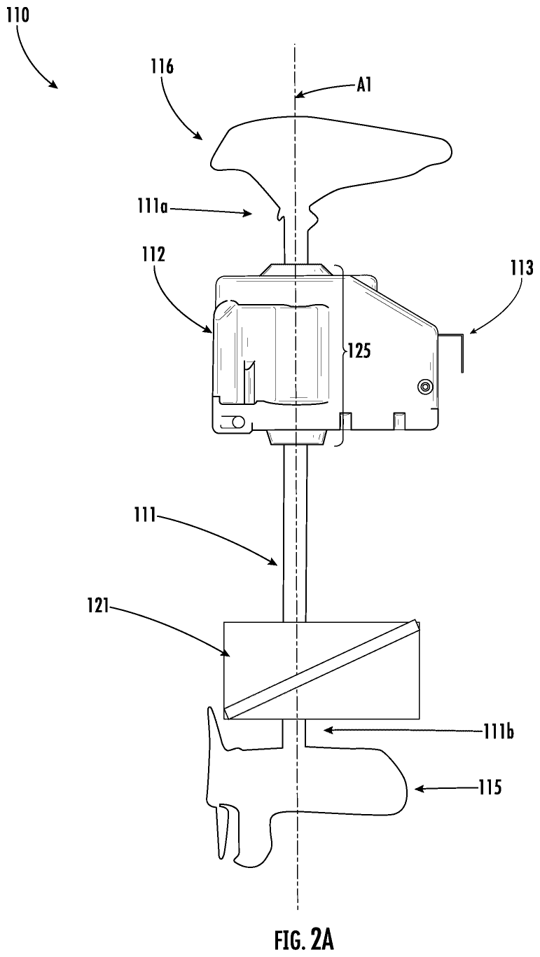

As depicted in FIG. 1, a watercraft 100 (e.g., a vessel) configured to traverse a marine environment, e.g., a body of water 101, may use a sonar assembly 121 disposed on and/or proximate to the watercraft 100. The watercraft 100 may be a surface watercraft, a submersible watercraft, or any other implementation known to those skilled in the art.

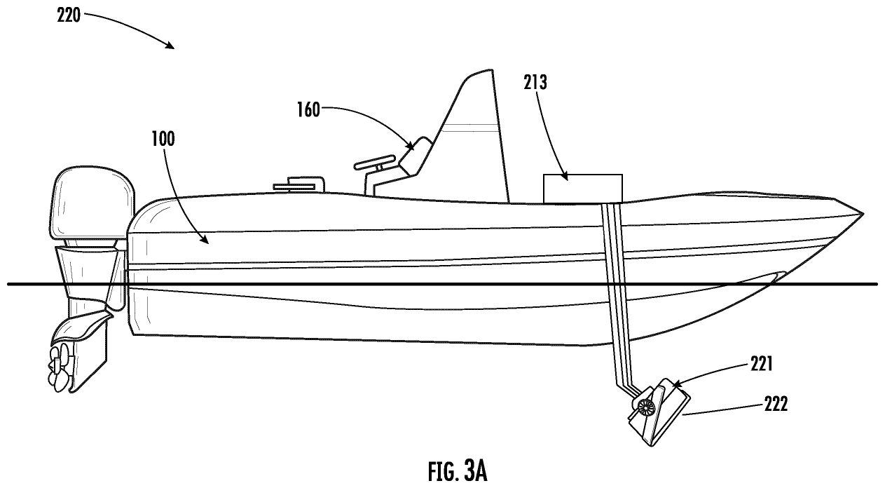

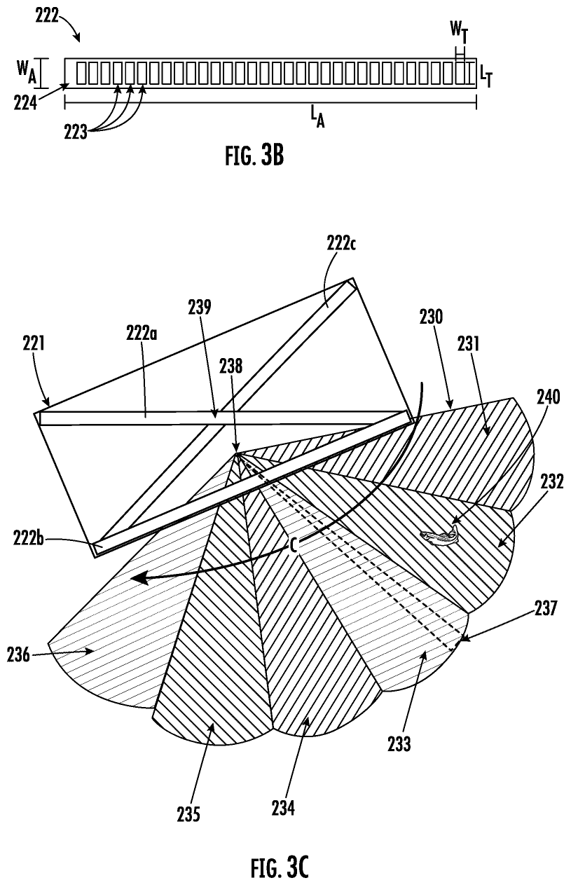

The sonar assembly 121 may be attached to and/or integrated into components of the watercraft 100. For example, in some embodiments, the sonar assembly 121 may be attached to a trolling motor 110 associated with the watercraft 100, a primary motor 118 associated with the watercraft 100, or a steering device 109 configured to attach to the watercraft 100. Accordingly, using, for example, the one of the motors to which it is attached and/or a dedicated steering assembly, the sonar assembly 121 may be configured to adjust its facing direction (e.g., rotate horizontally and/or vertically) and/or vertical position (e.g., up and down) in the underwater environment of the body of water 101 such that an emitting face (see. e.g., 224 in FIG. 3B) of the sonar assembly 121 may face any direction and at different depths.

According to some example embodiments the sonar assembly 121 may comprise one or more sonar transducer elements (see e.g., 223 in FIG. 3B). In some embodiments, the sonar assembly 121 may be manually steered, while in other embodiments the sonar assembly 121 may be steered by a sonar steering assembly and/or a motor. In some embodiments, the sonar assembly 121 may use a motor associated with a propulsion motor (e.g., the trolling motor 110 or the primary motor 118).

In an example embodiment, a fisherman 102 may cast a lure 140 into the body of water 101. The lure 140 may be attached to a line 104, extending from a fishing rod 103. In some embodiments, the fishing rod 103 may comprise a reel 106. In some embodiments, the type of reel 106 may determine the type of lure 140 to be used by the fisherman 102. In some embodiments, the sonar assembly 121 may be used to track the lure 140, such as when the fisherman 102 reels in the lure 140 to catch a fish, when the fisherman 102 settles the lure 140 in the underwater environment, etc.

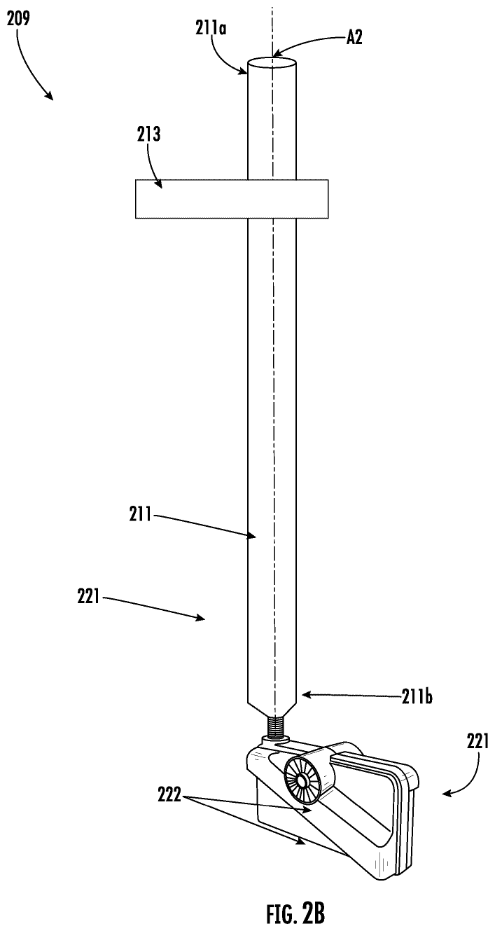

In some embodiments, the sonar assembly 121 is configured to adjust its facing direction (e.g., rotate and/or otherwise change orientation or position) such that the lure 140 may be maintained within a coverage volume of the one or more sonar transducer elements. FIG. 2A illustrates an example trolling motor 110 with an example sonar assembly 121 attached thereto such that it is rotatable and vertically adjustable with the shaft 111 of the trolling motor 110 (and may be independently able to further adjust its facing direction). Alternatively, the sonar assembly 121 may be independently adjustable in its facing direction from the trolling motor (e.g., it may have its own steering system even while being attached to the trolling motor 110.

In some embodiments, the trolling motor 110 may comprise a shaft 111 having a first end 111a and a second end 111b defining a trolling motor shaft axis A1 extending therebetween. The trolling motor 110 may include a main housing 116 attached to the first end 111a of the shaft 111, and a trolling motor housing 115 attached to the second end 111b of the shaft 111. In some embodiments, when the trolling motor 110 is attached to the watercraft, and the trolling motor housing 115 is submerged in the body of water, the trolling motor 110 is configured to propel the watercraft to travel along the body of water. In addition to containing the trolling motor, in some embodiments, the trolling motor housing 115 may include other components described herein including, for example, the sonar assembly 121 and/or other sensors (e.g., one or more sonar assemblies may be mounted within in or attached directly to the trolling motor housing 115).

The main housing 116 may be positioned outside of the body of water and is connected to the shaft 111 proximate the first end of the shaft 111a. The main housing 116 may be configured to house components of the trolling motor, such as may be used for processing marine or sensor data and/or controlling operation of the trolling motor among other things.

The trolling motor 110 may further include a system housing 112 fixed about the shaft 111 via a shaft attachment feature 125. In some embodiments, components of the system housing 112 may be configured to rotate the shaft 111 about the trolling motor shaft axis A1, and to move the shaft 111 vertically along the shaft axis A1 through the shaft attachment feature 125. In some embodiments, the rotational and vertical movement of the trolling motor 110 provides adjustment to the facing direction and/or position of the sonar assembly 121, and allows for positioning the sonar assembly 121 in a desired orientation (e.g., to direct the coverage volume).

In some embodiments, the sonar assembly 121 may be positioned within the trolling motor housing 115. In an alternative embodiment, the sonar assembly 121 may be positioned parallel to the trolling motor housing 115. For example, the sonar assembly 121 may be attached to a secondary shaft configured to rotate (e.g., up/down, left/right) and/or trim independently from the trolling motor shaft 111. In some embodiments, the secondary shaft may be attached to the system housing 112, such that any controls and operating mechanisms are in electrical communication with components within the system housing 112.

In some embodiments, the system housing 112 may include a watercraft attachment feature 113 to enable connection or attachment to the watercraft and/or a trolling motor mount. In some embodiments, the watercraft attachment feature 113 may allow for complete removal of the trolling motor 110 from the watercraft, while, in other embodiments, the watercraft attachment feature 113 may allow for hinging movement such that the trolling motor 110 may rotate about an attachment point such that the trolling motor housing 115 is removed from the body of water.

In some embodiments, the trolling motor and, thus, the sonar assembly 121 may be steered via foot control or even through use of a remote control.

In some embodiments, with reference to FIG. 2B, the sonar system may employ a steering device 209 to steer and attach a sonar assembly 221 to the watercraft. The steering device 209 may include a pole 211 extending from a first end 211a to a second end 211b along a pole axis A2. In some embodiments, the sonar assembly 221 may be attached to the second end 211b of the pole 211 such that the sonar assembly 221 may rotate about the pole axis A2 and pivot about the pole axis A2. In some embodiments, the pole 211 may include an attachment feature 213. The attachment feature 213 may be configured to attach the pole 211 to the watercraft.

In some embodiments, the pole 211 may define a hollow shaft to provide a pathway for electrical, mechanical, and data communication between the sonar assembly 211 and the watercraft (e.g., a steering system, marine electronics device, etc.). In some embodiments, a handle may be attached at the first end 211a for a user to manually steer the direction of the sonar assembly 221, although, in some embodiments, the handle, pole, or the steering assembly altogether may be controlled via automation, such as via various systems and components described herein.

In some embodiments, the sonar assembly 221 may comprise one or more transducer arrays 223 oriented in differing directions to provide a desirable coverage volume of the sonar assembly 221. The orientation of the coverage volume may be changed by changing the orientation of the sonar assembly 221. For example, the sonar assembly 221 may be oriented horizontally (such as pointing forward from the watercraft) and provide a sonar image that is wide (e.g., widest) in the horizontal plane. This orientation is often referred to being in “scout” mode. In this regard, the extended sonar beam coverage (e.g., ˜135°) may be used to see a wider view in the port-to-starboard direction with respect to the watercraft. Note, the broader coverage in the port-to-starboard direction results in a more narrow coverage (e.g., ˜20°) in the fore-and-aft direction. In other embodiments, the sonar assembly 221 may be oriented vertically (such as downward from the watercraft with the emitting face disposed in a vertical plane) and provide a sonar image that is wide (e.g., widest) in the vertical plane. This orientation is often referred to as being in the “forward” or “down” mode (e.g., depending on the relative facing direction of the center of the coverage volume with respect to the watercraft). In this regard, more narrow sonar beam coverage (e.g., ˜20°) may be used to see a more focused view in the port-to-starboard direction with respect to the watercraft.

Notably, while the above example embodiment details a certain coverage volume of one or more sonar beams, other coverage volumes are contemplated with respect to various embodiments of the present invention.

As discussed above, the orientation of the sonar assembly 221 and the configuration of the transducer arrays 222 dictate the orientation of and the coverage volume for the sonar system 220. In some embodiments, the orientation of the sonar assembly 221 may be maneuvered to achieve the desired orientation. For example, as illustrated in FIG. 3A, the sonar system 220 includes the sonar assembly 221 oriented in a first orientation. In some embodiments, the sonar assembly 221 may include multiple transducer arrays 222.

FIG. 3B illustrates an example transducer array 222 in detail. In the illustrated embodiment, the transducer array 222 includes an emitting face 224 with a length L_{A} and a width W_{A}, where the length is greater than the width. Within the transducer array 222, each sonar transducer element 223 defines an emitting face 226 with a length L_{T} and a width W_{T}, where the length is greater than the width. The length of each transducer element 223 is perpendicular to the length of the emitting face 224. Each sonar transducer element 223 is spaced at a predetermined distance from an adjacent sonar transducer element 233, which may be designed based on desired operating characteristics of the transducer array 222, such as described herein.

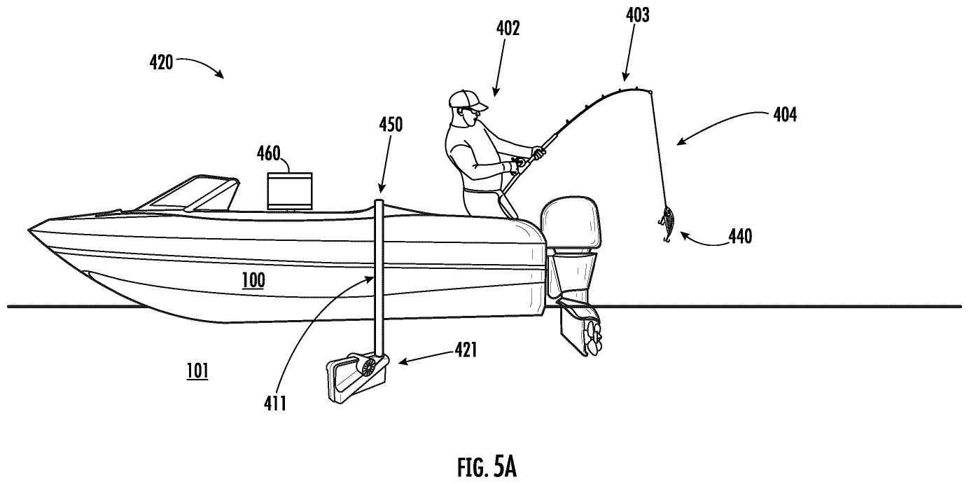

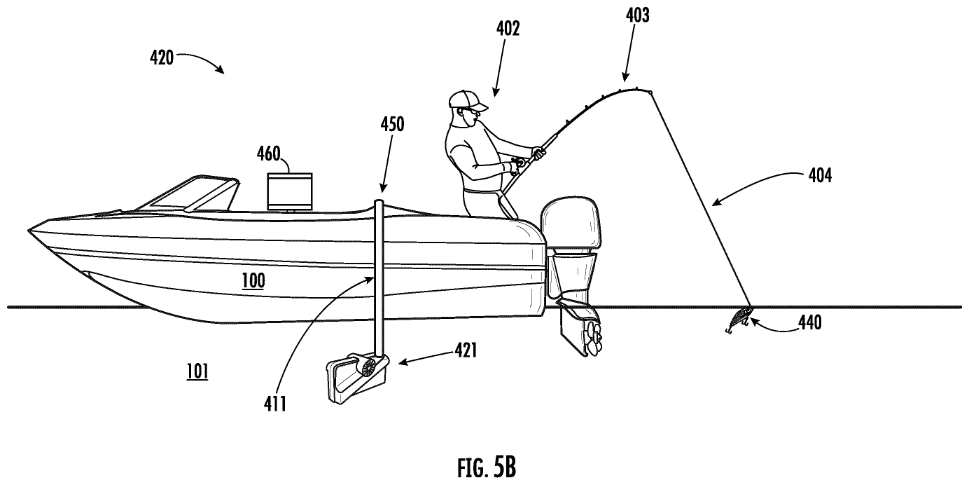

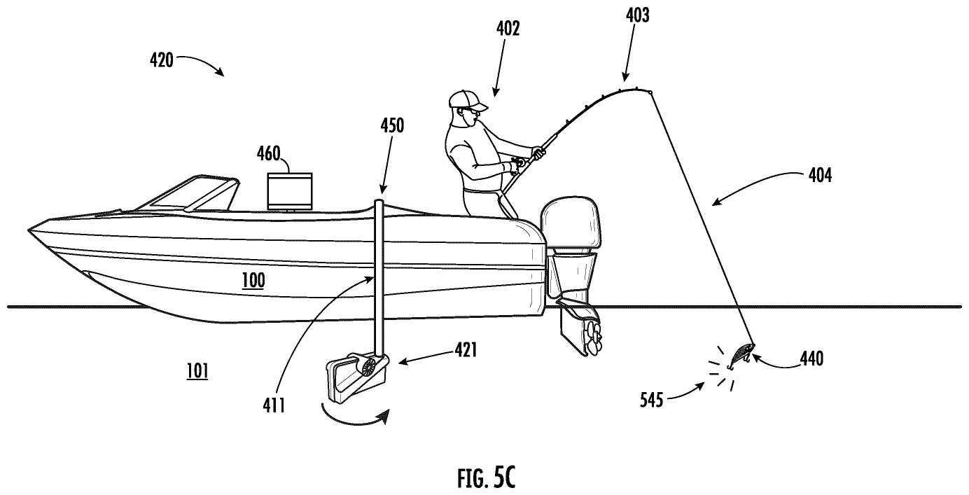

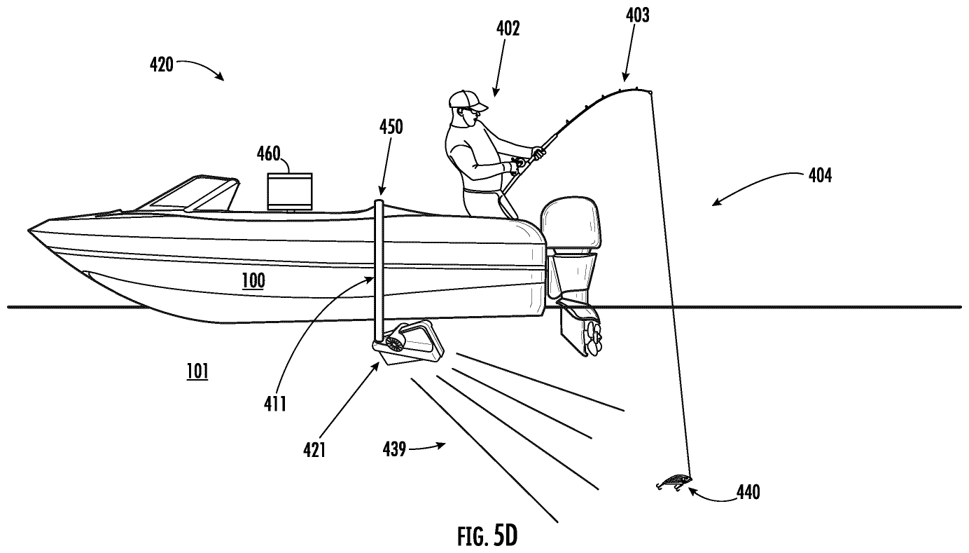

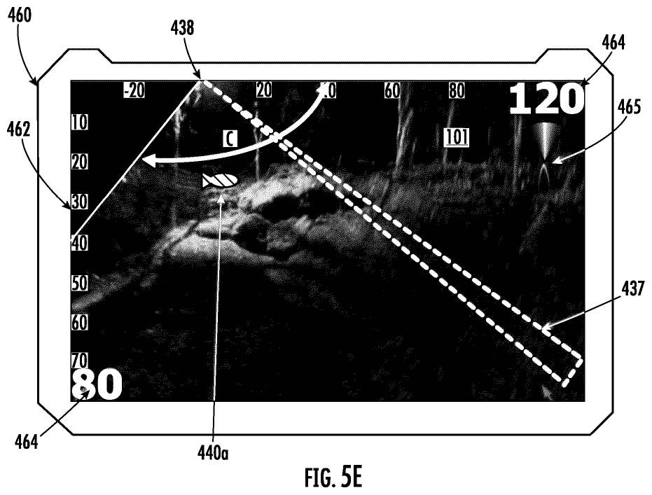

In some embodiments, the transducer array 222 is configured to operate to transmit one or more sonar beams (e.g., 439 in FIG. 5D) into the underwater environment. Depending on the configuration and desired operation, different transmission types of sonar beams can occur. For example, in some embodiments, the transducer array 222 may transmit sonar beams according to a frequency sweep (e.g., chirp sonar) so as to provide sonar beams into the underwater environment. In some embodiments, the transducer array 222 may be operated to frequency steer transmitted sonar beams into various volumes of the underwater environment. In some embodiments, the transducer array 222 may be operated to cause a broadband transmit sonar beam to be sent into the underwater environment. Depending on the frequency used and phase shift applied between transducer elements, different volumes of the underwater environment may be targeted.

In some embodiments, the transducer array 222 may be configured to receive sonar return signals. The way the sonar return signals are received and/or processed may vary depending on the desired sonar system configuration. In some embodiments, the sonar system may be configured to utilize more than one transducer array, where the transducer arrays are oriented relative to each other to increase coverage volume of the underwater environment. For example, in some embodiments, a second (or more) transducer array(s) can be added and tilted relative to the first transducer array such that the gap within the first transducer array is “covered” by one or more of the range of angles of sonar return beams from such array(s).

FIG. 3C illustrates an example sonar assembly 221 having three transducer arrays 222a, 222b, and 222c that is designed to provide continuous sonar coverage within a coverage volume 230 utilizing beamformed sonar return beams. The sonar assembly 221 includes a first array 222a, a second array 222b, and a third array 222c. The first array 222a is oriented with a facing direction (e.g., substantially straight down relative to the figure) so as to produce a first range of angles 236 and a second range of angles 233 (with a gap in between). In some embodiments, the second array 222b, is oriented with a facing direction at an angle (e.g., −22.5° relative to the facing direction of the first array 340) so as to produce a first range of angles 235 and a second range of angles 232 (with a gap in between). In some embodiments, the second array 222b may define the same center point 239 as the first array 222a or a shifted center point as illustrated. The third array 222c is oriented with a facing direction at another angle (e.g., −45° relative to the facing direction of the first array 222a) so as to produce a first range of angles 234 and a second range of angles 231 (with a gap in between). As so arranged, the gaps between each set of the two range of angles are covered by a range of angles from each of the other two arrays. The illustrated example thus provides continuous sonar beam coverage for ˜135°.

Notably, as illustrated, the first array 222a and the third array 222c are mounted at a similar center point, while the second array 222b of the transducer assembly 221 has been shifted (e.g., offset) while maintaining its relative angle orientation (e.g., it is still mounted with a facing direction at an angle (e.g., −22.5°) relative to the facing direction of the first array). Thus, the transducer assembly 221 forms an “X” configuration for the first array 222a and the third array 222c, but also has a line “_” at the bottom of the “X” corresponding to the second array 222b. Notably, the same relative continuous sonar beam coverage is obtained whether the second array 222b is aligned with the same center point 239, or a shifted center point (e.g., as the small relative shift from the center point does not significantly change the resulting beam coverage—particularly with respect to the distance covered in the underwater environment).

In some embodiments, the transducer assembly may be used to form a live (or substantially real-time) two-dimensional (2D) sonar image (e.g., time/distance from the transducer assembly and angle). For example, FIG. 3D illustrates a live 2D sonar image 262 presented on a display of a marine electronics device 260. The live 2D sonar image 262 is formed as slices of sonar return data corresponding to each sonar return beam 237 extending within that sonar beam coverage (e.g., along arrow C). In this regard, the live 2D sonar image 262 can be updated in substantially real-time all at once as they were all received at substantially the same time (e.g., by selecting different frequencies to form all the different sonar return beams that are used to present sonar return data into the image at the proper angle). The reference distance from the transducer assembly 238 (e.g., which correlates to distance from the transducer) is shown at 264. An icon detailing the facing direction in which the transducer assembly is facing relative to the watercraft is shown at 265.

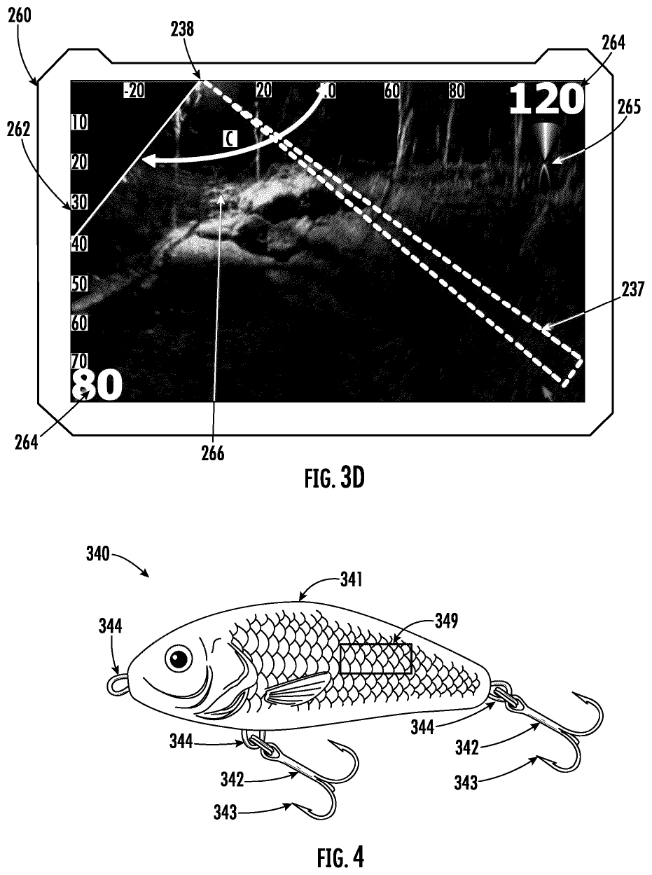

FIG. 4 illustrates an example lure 340 that may be used with the sonar system. The lure 340 may include a waterproof housing or body 341, such as for enclosing electronics within. In some embodiments, the electronics may be attached to or positioned adjacent or near the lure 340, such as on the fishing line. The lure 340 may include on or more hooks 342 disposed about the body 341, such as at a tail portion and a ventral portion. Each of the one or more hooks 342 may be interchangeably secured to the body 341 by an anchor loop 344 or other attachment feature. In some embodiments, the one or more hooks 342 may include a barb 343. In some embodiments, the one or more hooks 342 may be treble hooks.

In some embodiments, the lure 340 may include a bill or lip extending from a front side of the lure 340. The bill or lip may be configured to cause or aid the lure 340 to dive to a predetermined or expected depth. In some embodiments, the contour and/or weight of the body 341 may determine the predetermined or expected depth at which the lure 340 operates. Additionally, the contour of the body may cause the lure to deflect side-to-side when being reeled in, or “wobble.”

In some embodiments, the crank speed may affect the operating depth of the lure and the wobble of the lure. For example, if the lure 340 is subjected to an excessive crank speed, a larger than expected downward force may be applied, causing the lure 340 to operate at a depth greater than the expected depth. Similarly, if the lure 340 is subjected to an excessively low crank speed, a smaller than expected downward force may be applied, causing the lure 340 to operate at a depth less than the expected depth.

In an example embodiment, the lure 340 may be configured to collect and/or transmit data. The lure 340 may include a sensor assembly 349 including sensors and electronics, such as a time of flight sensor (e.g., an accelerometer, gyroscope, gravity switch) a signal generator, position sensor, receiver, light sensor, water sensor, transmitter or other sensors or systems.

The time of flight sensor may measure a change of state or direction of travel of the lure 340, such as when the direction of travel shifts from backwards to forwards during a cast and sudden deceleration of the lure 340 when the lure 340 strikes a body of water. In some embodiments, an accelerometer and/or a gyroscope may be used within the sensor assembly to detect movement of the lure 340, for example, corresponding to a fish bite, or other interaction of a fish or marine animal with the lure 340.

In some embodiments, the signal generator may be used to generate a beacon signal. The beacon signal may contain data collected from the sensor assembly 349. For example, in an embodiment, the beacon signal may be GPS coordinates of the lure 340. Thus, the lure 340 may have a position sensor to determine the GPS coordinates of the lure 340 and send the signal to a processor within the watercraft 100. In some embodiments, the position sensor may engage once the lure 340 hits the water and/or breaks the surface of the water.

In some embodiments, the signal generator may be used to generate a sonar signal. In some embodiments, the sonar signal may be the same frequency or a different frequency as the sonar system is designed to receive (or “look for”).

In some embodiments, the sensor assembly 349 may be battery powered. In some embodiments, the battery may be rechargeable. In some embodiments, the battery may have a life of 3-10 hours, 4-8 hours or 3-5 hours.

FIGS. 5A-D illustrate use of an example sonar system 420 to detect and track a lure 440 (e.g., a lure 440 attached to a fishing line 404 extending from a fishing rod 403). In particular, FIG. 5A illustrates an early stage cast of a fishing rod 403 by fisherman 402. FIG. 5B illustrates the lure 440 breaching the surface of the water 101. FIG. 5C illustrates the lure 440 emitting a beacon signal and corresponding rotation of a sonar assembly 421. FIG. 5D illustrates the sonar assembly 421 tracking the lure 440.

In reference to FIG. 5A, in the early stage of the cast, the lure 440 has not breached a surface of the body of water 101. The early stage of the case extends from prior to casting, to when the lure 440 hits the surface of the body of water 101.

In some embodiments, in the early stage, the sonar assembly 421 may be in a first facing direction, for example, aimed downwardly from the watercraft 100 (although other orientations are contemplated). In some embodiments, the sonar assembly 421 is in communication with a sonar steering assembly 450 (e.g., trolling motor 110, steering device 209, and/or other steering assembly) configured to adjust the facing direction of the sonar assembly 421 into the desired orientation. In some embodiments, the sonar assembly 421 is in communication with a marine electronics device 460.

In some embodiments, the fisherman 402 may prime the sonar assembly 421 such that one or more sonar transducer elements (e.g., 223 in FIG. 3) are oriented such that the facing direction is aimed in the direction of the cast. Priming the sonar assembly 421 may allow the sonar system 420 to detect the lure 440 within the sonar returns. Thus, the combination of priming the sonar assembly 421 and the smart lure, may allow the fisherman 402 to watch the live sonar of his reel after casting.

FIG. 5B illustrates the cast of the fisherman 402 as the lure 440 breaches the surface of the body of water 101. In some embodiments, the lure 440 may activate and determine when the lure 440 breaches the surface of the body of water 101 (e.g., via a water sensor, a light sensor, an accelerometer, etc.).

FIG. 5C illustrates the lure 440 submerged in the body of water 101. In some embodiments, as the lure 440 transitions between the surface of the water, as illustrated in FIG. 5B, into the body of water 101, the lure 440 is configured to emit a beacon signal 445.

As discussed above, the beacon signal 445b may contain a location, such as GPS coordinates, or a direction relative to the marine electronics device 460 on the watercraft 100. The beacon signal 445 may be received, wirelessly, such as by either the marine electronics device 460 or the sonar assembly 421. Upon determination of the beacon signal 445, the sonar steering assembly 450 may determine the lure position within the underwater environment and/or the relative lure position with respect to the current facing direction of the sonar assembly 412, and then cause the sonar assembly 421 to adjust its facing direction, such as indicated by the rotation arrow, such that the lure 440 is contained within a coverage volume of the sonar assembly 421 as illustrated in FIG. 5D. In this regard, the beacon signal may be determined based on receipt by the marine electronics device 460 or the sonar assembly 421 (or other electronics) and/or through filtering of sonar return data including the beacon signal.

In some embodiments, in this regard, for example, when the fisherman 402 primed the sonar assembly 421, the sonar system 420 may detect the position of the lure 440 within the sonar returns. The sonar steering system 450 may adjust the facing direction of the sonar assembly 421, indicated by the arrow, so the lure 440 is desirably positioned within the coverage volume of the sonar assembly 421 (e.g., centered, centered in a section, etc.).

In some embodiments, the beacon signal 445 may be configured as a sonar signal. As discussed above, in some embodiments, the sonar signal may be a different frequency than emitted sonar beams 439 from the sonar assembly 421. Thus, within the sonar image the lure 440 may appear distinct from other objects (e.g., the bottom of the body of water, fish, objects within the body of water etc.).

In some embodiments, the sonar system 420 may be configured to track the lure 440 and thereby allow the fisherman 402 to watch the underwater environment as the lure 440 is positioned therein. In some embodiments, the sonar system 420 may provide suggestions of lure positions.

In some embodiments, the lure 440 may to emit a beacon signal 445 at determined intervals, for example, every 1-5 seconds. The sonar system 420 may receive the beacon signals and cause the sonar steering assembly 450 to rotate to maintain the lure 420 within the coverage volume so as to track the lure's 440 movements through the body of water 101. Thus, as the fisherman 402 reels the lure 440 in or extends a line 404 to allow the lure 440 to descend further into the body of water 101 the sonar system 420 may be configured to adjust the facing direction and/or vertical position of the sonar transducers to maintain the lure within the generated sonar image.

In some embodiments, the sonar system 420 may identify the lure 440 within the sonar image and be configured to maintain the lure 440 within the image. In some embodiments, the sonar assembly 421 may be configured to rotate when the lure 440 is no longer present in the image, while in other embodiments, the sonar assembly 421 may be configured to rotate as the lure 440 moves to maintain a lure within the sonar image. For example, if the lure comes close to an edge of the coverage volume (e.g., within 10 degrees, 5 degrees, 10 ft, 5 ft, etc. of the edge), then the sonar assembly 421 will adjust such that the representation of the lure within the sonar image remains within the coverage volume before moving outside the coverage volume.

In some embodiments, the marine electronics device 460 may present the fisherman 402 with lure adjustments. For example, the marine electronics device 460 may have information stored in a memory of historical data of caught fish on the body of water, or depths certain fish species live between. Thus, based on the data from the lure 440, the orientation of the emitting face of the sonar assembly 421 and the data in the memory, the sonar system 420 may present adjustments (i.e., reel in 10 feet, release 10 feet) to enhance the fisherman's 402 ability to catch a fish on each cast. In some embodiments, the lure adjustments may be recommendations for where to move the lure to bring the lure within a current coverage volume (e.g., so a representation of the lure appears in the sonar image).

As illustrated in FIG. 5E, the marine electronics device 460 may present a sonar image 462 displaying a representation of the underwater environment within the coverage volume 430. In some embodiments, a representation 440a of the lure 440 may be presented in a different pattern or highlight than other objects within the sonar image. In some embodiments, the pattern may be determined due to the sonar signals emitted by the lure 440 received by the sonar assembly 421, while in other embodiments, the pattern may be determined by beacon signal containing the location of the lure. Thus, rather than the fisherman 402 seeing a single object in the sonar image, the fisherman may easily distinguish between the representation 440a of the lure 440 and fish or other objects within the sonar image 462.

In some embodiments, the fisherman 402 may select the representation 440a of the lure 440 within the sonar image 462. The sonar system 420 may use the user selection to detect the lure 440 within the sonar return data, determine one or more signals (e.g., beacon signal, sonar signals, etc.) as the lure, continuously or periodically determine a position of such one or more signals, and then maintain the selected indication 440a within the coverage volume 430 of the sonar assembly 421 (e.g., by adjusting the coverage volume of the sonar assembly 421 to track the lure).

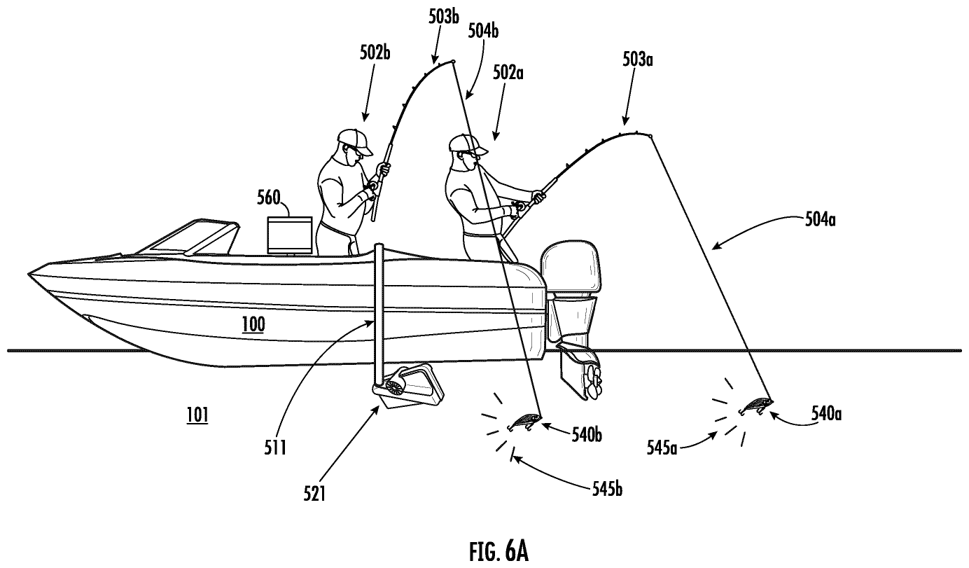

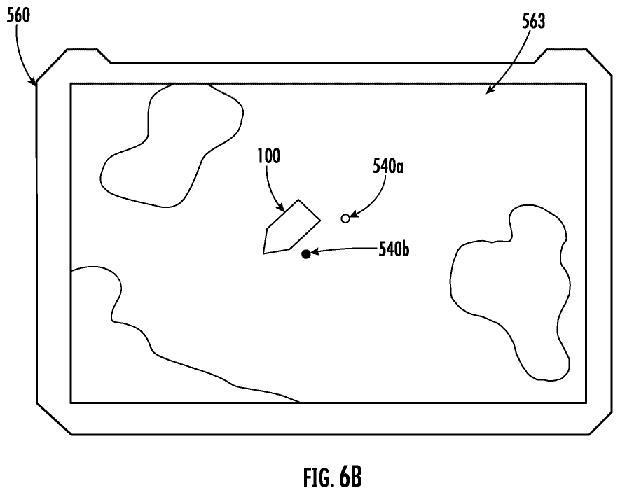

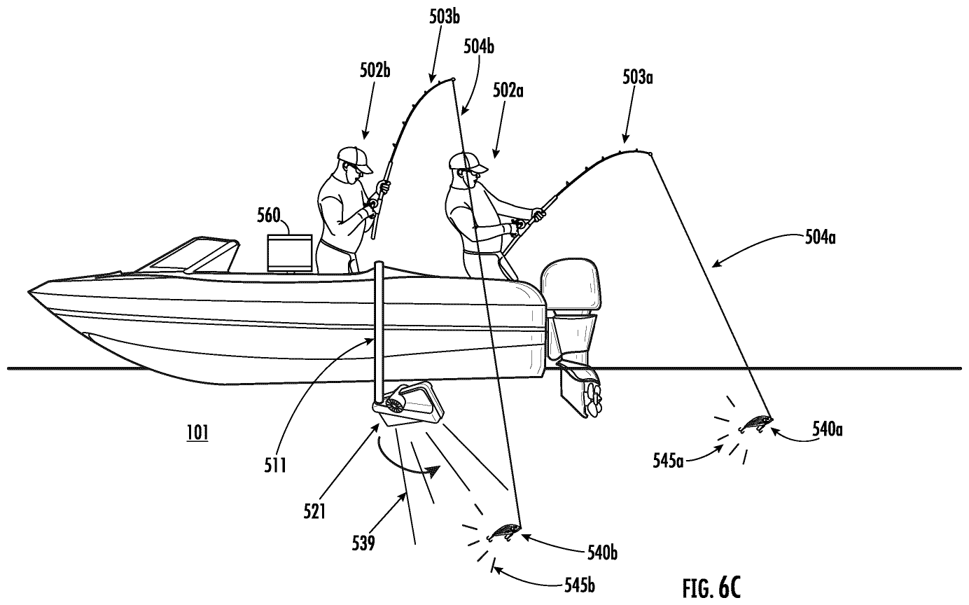

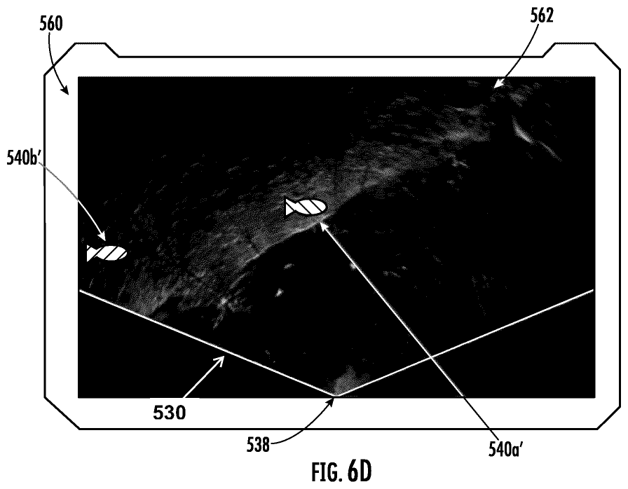

In another example embodiment, with reference to FIG. 6A, the watercraft 100 may have more than one fisherman 502a, 502b fishing. Thus, the first fisherman 502a may have a first fishing rod 503a and a first lure 540a, and the second fisherman 502b may have a second fishing rod 503b and a second lure 540b. The first lure 540a may emit a first beacon signal 545a and the second lure 540b may emit a second beacon signal 545b. In some embodiments, the first fisherman 502a may have more than one rod, rather than the first rod 503a and the second rod 403b being operated by different fishermen.

As discussed with reference to FIGS. 5A-E, the sonar system 520 may be designed to detect and track one or both of the first lure 540a and the second lure 540b. Each of the first beacon signal 545a and the second beacon signal 545b may contain corresponding position information, such as described herein. In some embodiments, the position information may be a location relative to the watercraft, while in other embodiments the position information may be GPS data. In some embodiments, as illustrated in FIG. 6B, the position of each of the first lure 540a and the second lure 450b may be displayed on a navigational chart 563 presented on a marine electronics device 560. In some embodiments, each of the first lure 540a and the second lure 540b may be presented in different highlights on the navigational chart 563.

In some embodiments, the navigational chart 563 and a sonar image 562 (e.g., shown in FIG. 6D) may be flipped between to allow the users to switch the lure being tracked or presented at a given time. In some embodiments, one of the fishermen 502a, 502b or another passenger may select either the first lure 504a or the second lure 504b to be displayed within a sonar image. Upon selection of either the first lure 540a or the second lure 540b, a sonar steering assembly 550 may cause a sonar assembly 521 to adjust its facing direction such that the selected lure (e.g., lure 540b) is within the coverage volume of the sonar assembly 521, such as illustrated in FIG. 6C.

In some embodiments, the fishermen 503a, 503b may transition between the first lure 540a and the second lure 540b as needed, for example, when one fisherman detects a bite. In some embodiments, the lures 540a, 540b may send out a secondary signal or beacon signal. For example, in an example embodiment, the sonar system 520 may be tracking the second lure 540b, and the first lure 540a may send a secondary signal to the sonar system 520 indicating an uncharacteristic movement of the first lure 540a. In some embodiments, the uncharacteristic movement may be a sudden drop, or rotation, corresponding with a bite or an interaction with a fish or other animal. Upon receiving the secondary signal or the beacon signal, the sonar system 520 may either automatically cause the sonar steering assembly 550 to rotate the sonar transducer 521 to position the first lure 540a within the coverage volume or present an option on the marine electronics device to rotate the sonar assembly 521 to position the first lure 540a within the coverage volume.

In some embodiments, the sonar system 520 may be able to capture both the first lure 540a and the second lure 540b in a single sonar image. In this regard, as illustrated in FIG. 6D, the sonar assembly 521 may have adjusted its facing direction such that the sonar image 562 includes a first representation 540a′ indicating the first lure 540a and a second representation 540b′ indicating the second lure 540b (e.g., both lures are within the coverage volume 530).

### Example System Architecture

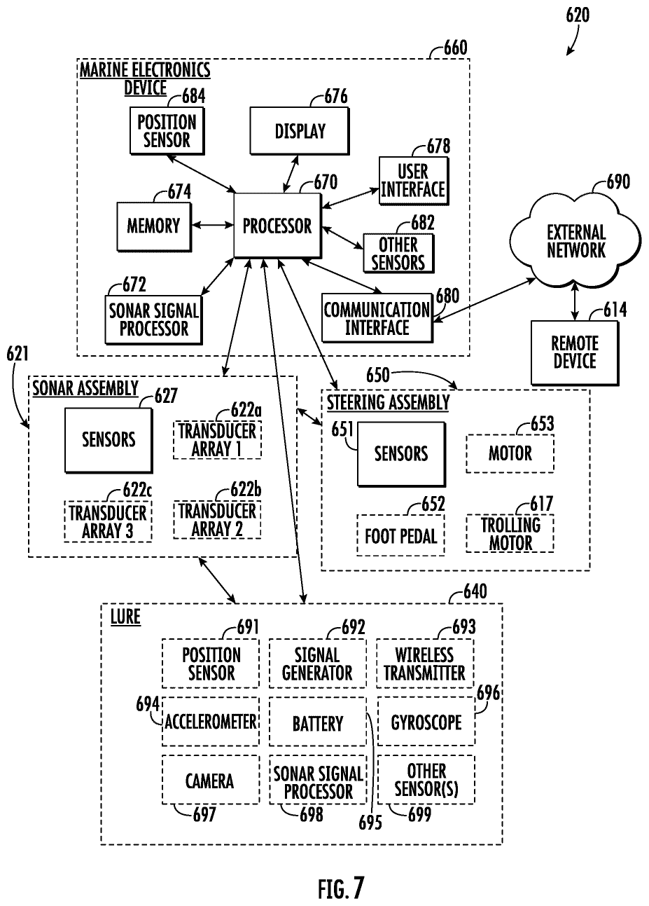

FIG. 7 illustrates an example schematic of a sonar system 620 used by various embodiments described herein. The sonar system 620 may include a marine electronics device 600, such as marine electronics device 160, 260, 460, 560, in accordance with implementations of various techniques described herein, a sonar assembly 621, a steering assembly 650, and a lure 640.

As described herein, it is contemplated that while certain components and functionalities of components may be shown and described as being part of the marine electronics device 660, the sonar assembly 621, the steering assembly 650 and/or the lure 640, according to some example embodiments, some components (e.g., functionalities of the processors 670, or the like) may be included in the others of the sonar assembly 621, marine electronics device 660, the lure 640, the steering assembly 650, or one or more remote devices 614.

As depicted in FIG. 7, the sonar system 620 may include a marine electronics device 660. In some embodiments, the marine electronics device 660 may include a processor 670, a memory 674, a position sensor 684, a display 676, a user interface 678, a sonar signal processor 672, a communication interface 680, and various other sensors or systems 682.

In some embodiments, the processor 670 may be any means configured to execute various programmed operations or instructions stored in a memory device such as a device or circuitry operating in accordance with software or otherwise embodied in hardware or a combination of hardware and software (e.g., a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 670 as described herein. In this regard, the processor 670 may be configured to analyze electrical signals communicated thereto in the form of a directional input signal and instruct a motor 653 to rotate the sonar assembly 621 to rotate the one or more transducer arrays 622a, 622b, 622c in accordance with a received rotational signal. In an example embodiment, the direction input signal may be generated by a foot pedal 652 in data communication with the processor 670, while in some embodiments the direction input signal may be generated by a remote device 614.

The memory 674 may be configured to store instructions, computer program code, trolling motor steering codes and instructions, sonar steering codes and instructions marine data, such as sonar data, chart data, location/position data, and other data in a non-transitory computer readable medium for use, such as by the processor 670.

The communication interface 680 may be configured to enable connection to external systems. In this manner, the processor 670 may retrieve stored data from remote external servers 690 via the communication interface 680, in addition to or as an alternative to the memory 674.

The processor 670 of the sonar system 620 may be in communication with and control the steering assembly 650. The steering assembly 650 may include the motor 653. The motor 653 may be an electronically controlled mechanical actuator (i.e., an electro-mechanical actuator) configured to actuate at various rates (or speeds) in response to respective signals or instructions. The motor 653 may be configured to rotate the sonar assembly 621 and, therefore, the one or more transducer arrays 622a, 622b, 622c, regardless of the means for doing so, in response to electrical signals. Similarly, the motor 653, may be configured to adjust the facing direction of the sonar assembly 621 relative to the bottom of the watercraft, regardless of the means for doing so in response to electrical signals. To do so, the motor 653 may employ a solenoid, a motor, or the like configured to convert an electrical signal into a mechanical movement. The range of motion to turn the sonar assembly 621 may be about the first axis (FIG. 2A) or the second axis (FIG. 2B) may be 360 degrees, 180 degrees, 90 degrees, 37 degrees, or the like, in a horizontal plane and/or may be in a vertical plane up to 360 degrees, 270 degrees, 180 degrees, 90 degrees, etc. As detailed herein, in some embodiments, the sonar assembly 621 may be attached to a rotatable structure, such as a main propulsion motor and/or trolling motor that may control and/or aid in adjusting the facing direction of the sonar assembly 621.

The sonar assembly 621 may be in a housing attached to the steering assembly 650 and configured to gather sonar data from the underwater environment surrounding the watercraft. Accordingly, the processor 670 (such as through execution of computer program code) or other processor may be configured to receive sonar data from the sonar assembly 621 and process the sonar data to generate an image based on the gathered sonar data. In some example embodiments, the sonar system 620 may be used to determine depth and bottom topography, detect fish, locate wreckage, track and follow lures, etc. Sonar beams, from one or more transducer arrays 622a, 622b, 622c may be transmitted into the underwater environment and echoes can be detected to obtain information about the environment. In this regard, the sonar signals can reflect off objects in the underwater environment (e.g., fish, structures, sea floor bottom, etc.) and return to the sonar assembly 621, which converts the sonar returns into sonar data that can be used to produce an image of the underwater environment.

As detailed herein, while an example sonar assembly 621 includes three transducer arrays of multiple transducer elements, any configuration of a sonar assembly (or multiple sonar assemblies) is contemplated for use with various example embodiments. Such sonar may provide live sonar imagery and/or historical based sonar imagery.

According to some example embodiments, the sonar system 620 may include or be in communication with a display 676 to render the sonar image for display to a user. In some embodiments, the sonar system 621 may be configured to track the lure as additional sonar data is captured and processed by the sonar signal processor 672. In some such embodiments, the sonar system 620 may be configured to present an indicator on the display 676 of the marine electronics device 660 in corresponding positions as the lure moves (and/or the watercraft moves with respect to the object) —thereby “tracking” the object within a sonar image.

In this regard, in some embodiments, the sonar system 620 may be configured to track the lure 640. The lure 640 may include electronics including a position sensor 691, a signal generator 692, a wireless transmitter 693, an accelerometer 694, a battery 695, a gyroscope 696, a camera 697, a sonar signal processor 698, and/or other sensors/systems (e.g., light sensor, depth sensor, etc.). The position sensor 691 may be configured to determine the location of the lure 640. In some embodiments, the position sensor 621 may be a general location relative to the watercraft. In this regard the position sensor 691 may indicate that the lure 640 is located on the port side, on the starboard side, etc. In other embodiments, the position sensor 621 may be configured to determine the geographical coordinates of the lure 640.

In some embodiments, the position sensor 691 may be in communication with the processor 670 such that the processor 670 may cause the steering assembly 650 to rotate the sonar assembly 621 so the emitting face of the transducer array 622 is facing the lure 640 (or such that the corresponding coverage volume includes the lure). In some embodiments, the wireless transmitter 693 may be configured to emit a beacon signal generated by the signal generator 692 to be received by the marine electronics device 660.

In some embodiments, the accelerometer 694 and the gyroscope 696 may be configured to collect data about the position and the movement of the lure 640 within the body of water. In some embodiments, the camera 697 of the lure 640 may be an underwater camera configured to take a picture or video in response to movement detected by either the accelerometer 694 or the gyroscope 696.

In some embodiments, the lure 640 may be configured to receive and emit sonar signals. In some embodiments, the sonar signal processor 698 of the lure 640 may detect a sonar signal emitted by the transducer array 622. In response the sonar signal processor 698 may emit the beacon signal and/or a sonar signal (such as may be at a different frequency than the sonar signal received).

In some embodiments, the battery 695 may be a rechargeable battery. In some embodiments, the battery 695 may have a finite life and may be configured to be changed after the expiration of the life.

In some embodiments, the lure 640 may include other sensors or systems, such as a depth sensor and/or a light sensor. The depth sensor may be configured to determine a current depth of the lure, which may be communicated to the processor 670 for determining the position/location of the lure within the underwater environment (e.g., in conjunction with the position sensor 691). The light sensor may be configured to determine an amount of light relative to the lure, which may be used in conjunction with various functionality described herein (e.g., determining when the lure enters the water, etc.).

In some embodiments, the processor 670 may be configured to send electrical signals to the steering assembly 650 to adjust the facing direction of the sonar assembly 621 so as to include the lure 640 within the coverage volume. In some embodiments, the steering assembly 650 may provide electrical communication between the foot pedal 652 and the sonar assembly 621, while in other embodiments, the steering assembly 650 may provide electrical communication between a trolling motor 617 and the sonar assembly 621. In some embodiments, the steering assembly 650 may include sensors 651, the sensors 651 may be configured to determine a facing direction of the steering assembly 650 and/or the sonar assembly 621.

In some embodiments, the steering assembly 650 may be configured to rotate the sonar assembly 621 to a desired orientation corresponding to a mode, or a position between commonly used modes. As discussed above, the sonar assembly 621 may define differing orientations depending on the sonar image desired, the operation of the sonar assembly 621 and the location of the lure 640. In some embodiments, the sonar system 620 may have one or more modes stored in the memory 674 of the marine electronics device 660 such that when executed, the processor 670 may cause the motor 653 to rotate the steering assembly 650 such that the sonar assembly 621 is in the desired orientation. In some embodiments, the mode may be scout mode, forward mode, and down mode.

### Example Flowchart(s) and Operations

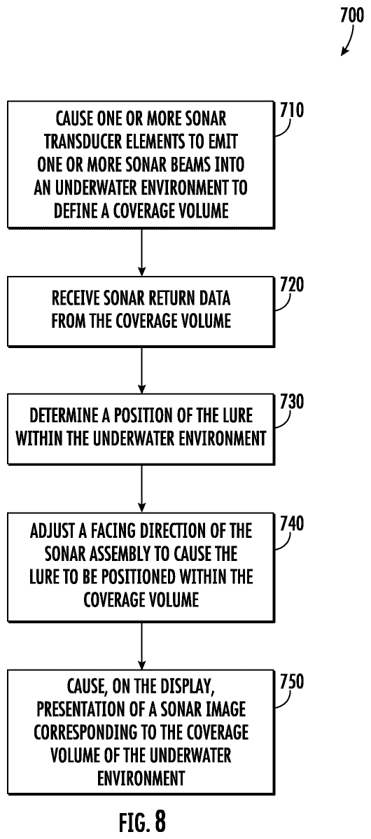

Some embodiments of the present invention provide methods, apparatus, and computer program products related to controlling a sonar assembly and/or presenting information according to various embodiments described herein. Various examples of the operations performed in accordance with embodiments of the present invention will now be provided with reference to FIG. 8. FIG. 8 presents a flowchart with example method(s) 700 of tracking a lure within an underwater environment. These methods may be performed by a wide variety of components, including, but not limited to, one or more processors, one or more microprocessors, and one or more controllers. In some embodiments, a marine electronic device 660 (FIG. 7) may comprise one or more processors that perform the functions shown in FIG. 8. Further, these methods may be provided on a piece of software which runs on a central server that is at a remote location away from the watercraft, and the remote server may communicate with a processor or a similar component on the watercraft. Additionally, the methods could be integrated into a software update that may be installed onto existing hardware, or the methods may be integrated into the initial software or hardware provided in a remote server, remote device, etc.

FIG. 8 illustrates a flowchart according to example methods 700 of detecting and tracking a lure in an underwater environment according to an example embodiment. The operations illustrated and described with respect to FIG. 8 may, for example, be performed by, with the assistance of, and/or under the control of one or more the processor 670, memory 674, communication interface 680, user interface 678, position sensor 684, other sensors 682, sonar assembly 621, display 676, steering assembly 650, lure 640, and/or external network 690/remote device 614.

FIG. 8, illustrates an example method 700. The method 700 may include causing one or more sonar transducer elements to emit one or more sonar beams into an underwater environment to define a coverage volume at operation 710. The method 700 may continue by receiving sonar return data from the coverage volume at operation 720. The method 700 may continue by determining a position of the lure within the underwater environment at operation 730. The method 700 may continue by adjusting a facing direction of the sonar assembly to cause the lure to be positioned within the coverage volume at operation 740. The method 700 may continue by causing, on a display, presentation of a sonar image corresponding to the coverage volume of the underwater environment at operation 750.

FIG. 8 illustrates a flowchart of a system, method, and computer program product according to various example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 674 and executed by, for example, the processor 670. As will be appreciated, any such computer program product may be loaded onto a computer or other programmable apparatus (for example, a marine electronic device 660) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 660) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A sonar system comprising:
a sonar assembly configured to attach to a motor associated with a watercraft, wherein the motor is configured to propel the watercraft to travel along a direction of travel in a body of water, the sonar assembly comprising:
one or more sonar transducer elements, wherein the one or more sonar transducer elements are configured to transmit one or more sonar beams into an underwater environment relative to a facing direction, wherein the facing direction dictates a coverage volume of the one or more sonar beams within the underwater environment;
a display;
one or more processors; and
a memory including computer program code configured to, when executed, cause the one or more processors to:
cause the one or more sonar transducer elements to emit the one or more sonar beams into the underwater environment to define the coverage volume;
receive sonar return data from the coverage volume of the one or more sonar transducer elements;
determine, based on a beacon signal emitted by a lure, a position of the lure within the underwater environment;
adjust the facing direction of the sonar assembly to cause the lure to be positioned within the coverage volume; and
cause, on the display, presentation of a sonar image corresponding to the coverage volume of the underwater environment, wherein the sonar image includes a representation of the lure within the coverage volume.

2. The system of claim 1, wherein the lure comprises at least one sensor, and wherein the beacon signal is emitted after the at least one sensor detects water from the underwater environment.

3. The system of claim 1, wherein the computer program code is further configured to, when executed, cause the one or more processors to:
receive indication of a user selection of the representation of the lure within the sonar image;
receive updated sonar return data from the coverage volume of the one or more sonar transducer elements indicating an updated position of the lure; and
adjust the facing direction of the sonar assembly to cause the updated position of the lure to be centered within the coverage volume, so as to track the lure within the sonar image.

4. The system of claim 1, wherein the orientation of the sonar assembly is adjusted by at least one of rotating or trimming the motor associated with the watercraft.

5. The system of claim 1, wherein the beacon signal is a sonar signal, and wherein the presentation of the sonar image on the display distinguishes between sonar return data and the sonar signal emitted by the lure.

6. The system of claim 1, wherein the beacon signal is a GPS position, and wherein the computer program code is configured to, when executed, cause the one or more processors to:
cause, in response to receiving the beacon signal emitted by the lure, the sonar assembly to rotate such that the representation of the lure is centered within the sonar image.

7. The system of claim 1, wherein the lure is a first lure and a second lure, and wherein the computer program code is configured to, when executed, cause the one or more processors to:
determine, based on a first beacon signal emitted by the first lure, a position of the first lure within the underwater environment;
determine, based on a second beacon signal emitted by the second lure, a position of the second lure within the underwater environment; and
adjust the facing direction of the sonar assembly to cause at least one of the first lure and the second lure to be positioned within the coverage volume.

8. The system of claim 1, wherein the motor associated with the watercraft comprises a steering system, and
wherein the lure is a first lure and a second lure, and
wherein the computer program code is further configured to, when executed, cause the one or more processors to:
determine, based on a first beacon signal emitted by the first lure, a position of the first lure within the underwater environment;
determine, based on a second beacon signal emitted by the second lure, a position of the second lure within the underwater environment;
receive a user input selecting one of the first lure or the second lure; and
adjust the facing direction of the sonar assembly to cause the selected first or second lure to be positioned within the coverage volume.

9. The system of claim 1, wherein the sonar image is a two-dimensional live sonar image formed from the sonar return data.

10. The system of claim 1, wherein the computer program code is further configured to, when executed, cause the one or more processors to:
cause, on the display, indication of at least one lure adjustment to direct a user where to move the lure from the position to a second position within the underwater environment that is within the coverage volume.

11. The system of claim 1, wherein the beacon signal is a wireless signal.

12. A sonar system comprising:
a sonar assembly configured to attach to a watercraft, the sonar assembly comprising:
one or more sonar transducer elements, wherein the one or more sonar transducer elements are configured to transmit one or more sonar beams into an underwater environment relative to a facing direction, wherein the facing direction dictates a coverage volume of the one or more sonar beams within the underwater environment;
a sonar steering assembly configured to adjust the facing direction of the one or more sonar transducer elements relative to the watercraft;
a display;
one or more processors; and
a memory include computer program code configured to, when executed, cause the one or more processors to:
cause the one or more sonar transducer elements to emit the one or more sonar beams into the underwater environment to define the coverage volume;
receive sonar return data from the coverage volume of the one or more sonar transducer elements;
determine, based on a beacon signal emitted by a lure, a position of the lure within the underwater environment;
adjust, via the sonar steering assembly, the facing direction of the sonar assembly to cause the lure to be positioned within the coverage volume; and
cause, on the display, presentation of a sonar image corresponding to the coverage volume of the underwater environment, wherein the sonar image includes a representation of the lure within the coverage volume.

13. The system of claim 12, wherein the lure comprises at least one sensor, and wherein the beacon signal is emitted after the at least one sensor detects water from the underwater environment.

14. The system of claim 12, wherein the computer program code is further configured to, when executed, cause the one or more processors to:
receive indication of a user selection of the representation of the lure within the sonar image;
receive updated sonar return data from the coverage volume of the one or more sonar transducer elements indicating an updated position of the lure; and
cause the sonar steering assembly to adjust the facing direction of the sonar assembly to cause the updated position of the lure to be centered within the coverage volume, so as to track the lure within the sonar image.

15. The system of claim 12, wherein the lure is a first lure and a second lure, and wherein the computer program code is configured to, when executed, cause the one or more processors to:
determine, based on a first beacon signal emitted by the first lure, a position of the first lure within the underwater environment;
determine, based on a second beacon signal emitted by the second lure, a position of the second lure within the underwater environment; and
adjust the facing direction of the sonar assembly to cause at least one of the first lure and the second lure to be positioned within the coverage volume.

16. The system of claim 12, wherein the computer program code is further configured to, when executed, cause the processor to:
cause, on the display, indication of at least one lure adjustment to direct a user where to move the lure from the position to a second position within the underwater environment that is within the coverage volume.

17. A method for adjusting a facing direction of a sonar assembly, the method comprising:
causing one or more sonar transducer elements of the sonar assembly to emit one or more sonar beams into the underwater environment to define a coverage volume;
receiving sonar return data from the coverage volume of the one or more sonar transducer elements;
determining, based on a beacon signal emitted by a lure, a position of the lure within the underwater environment;
adjusting, via a steering system attached to the sonar assembly or a motor to which the sonar assembly is attached, the facing direction of the sonar assembly to cause the lure to be positioned within the coverage volume; and
causing, on the display, presentation of a sonar image corresponding to the coverage volume of the underwater environment, wherein the sonar image includes a representation of the lure within the coverage volume.

18. The method of claim 17, wherein the lure comprises at least one sensor, and wherein the beacon signal is emitted after the at least one sensor detects water from the underwater environment.

19. The method of claim 17, further comprising:
receiving indication of a user selection of the representation of the lure within the sonar image;
receiving, updated sonar return data from the coverage volume of the one or more sonar transducer elements indicating an updated position of the lure; and
adjusting the facing direction of the sonar assembly to cause the updated position of the lure to be centered within the coverage volume, so as to track the lure within the sonar image.

20. The method of claim 17, wherein the lure is a first lure and a second lure, the method further comprising:
determining, based on a first beacon signal emitted by the first lure, a position of the first lure within the underwater environment;
determining, based on a second beacon signal emitted by the second lure, a position of the second lure within the underwater environment; and
adjusting the facing direction of the sonar assembly to cause at least one of the first lure and the second lure to be positioned within the coverage volume.
